(19) United States
(12) Patent Application Publication
(10) Pub. No.: US 2007/0084072 A1
(43) Pub. Date: Apr. 19, 2007

(54) Kite square

(76) Inventor: Jimmie Andrew Miller, Salisbury, NC (US)

Correspondence Address: Jimmie Andrew Miller, 139 Spring Oak Drive, Salisbury, NC, 28147, US

(21) Appl. No.: 11/254,608

(22) Filed: Oct. 17, 2005

(51) Int. Cl. B43L 7/027

(52) U.S. Cl. 33/474

(57) ABSTRACT

This invention provides a framework for simplified and rigorous methods and means for the determination of the squareness error between two orthogonally driven carriages of a machine. The method uses the principle of a geometric kite in which the lines formed between opposing vertices are inherently orthogonal. By utilizing a partial kite-shaped structure having three measurable datums associated with three of the vertices of a geometric kite and by rotating the structure about the line of rotation formed by two of the three datums, the positions of the third vertex will form a circle that has the property the plane in which it lies is orthogonal to the original line. Additionally, any two points located on the circle will form a line that is orthogonal to the line of rotation. The structure is measured in multiple orientations attached to the table of a machine.

### CROSS-REFERENCE TO RELATED APPLICATIONS

This non-provisional patent application is a new application and has no current cross references.

### FIELD OF THE INVENTION

This present invention relates generally to calibration and parametric evaluation of machine tools used for manufacturing and inspection.

### BACKGROUND

National and international standards exist for measuring the geometric performance accuracy of machine tools and coordinate measuring machines. These standards give alternate methods for measuring the straightness and squareness errors of those machines. Because of the way straightness and squareness are defined metrologically, it is possible for differing tests on the same machine to give differing error magnitudes for each error. The straightness measurement techniques include using mechanical straightedges, optical straightedges, taut wires, alignment lasers, and straightness interferometers. Squareness is often measured/calculated by using squareness artifacts which have a calibrated right angle between two reference lines. These artifacts are placed in the working volume facilitating the measurement of straightness along two nominally perpendicular lines. Straightness data taken from the lines are then =1 best fit=2 =0 using least squares algorithms to obtain the slopes to be removed from these lines to obtain the straightness data. The slopes can then be used to mathematically derive the squareness error between two perpendicular linear stages. Optical and mechanical squares dictate where they can be placed on the machine since they require a significant portion of the working range to be used. The method and means presented here allows the determination of the squareness of a machine through the center of the work zone using data that may extend any chosen length throughout the full range of travel for both of the nominally orthogonal carriages. It also provides a scalable means for characterizing machines having a small working range.

### SUMMARY OF THE INVENTION

This invention provides a framework for simplified and rigorous methods and means for the determination of the squareness error between two orthogonally driven carriages of a machine. The method uses the principle of a geometric kite in which the lines formed between opposing vertices are inherently orthogonal. By utilizing a partial kite-shaped structure having three measurable datums associated with three of the vertices of a geometric kite and by rotating the structure about the line of rotation formed by two of the three datums, the positions of the third vertex will form a circle that has the property the plane in which it lies is orthogonal to the original line. Additionally, any two points located on the circle will form a line that is orthogonal to the line of rotation. The gage or any part thereof does not require calibration in order to determine the squareness error.

### BRIEF DESCRIPTION OF THE DRAWINGS

FIG. 1 is a planar view of one embodiment of a kite square using three rigidly connected precision spheres for datum realization. The drawing shows the device in two opposing orientations which realize the geometric kite and thus orthogonal lines associated with the datums.

FIG. 2 is a planar view of a second embodiment in which precision spheres provide rotation but separate artifacts provide the datums to realize the vertices of the kite. The drawing shows the device in two orthogonal orientations for realization of geometric kite vertices for determining orthogonal lines.

FIG. 3 is a perspective view of a machine having the kite square gage situated in one orientation on the table of the machine.

### DETAILED DESCRIPTION

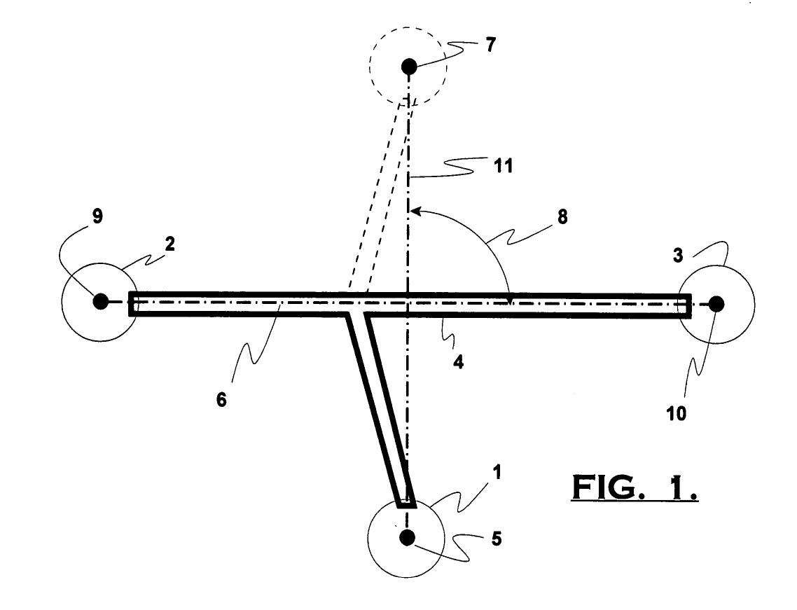

FIG. 1 shows the planar view of a kite square gage consisting of three spheres 1, 2, and 3 attached together via a rigid support structure 4. The three spheres 1, 2 and 3 are at positions 5, 9 and 10, respectively. Let us allow the rotation of spheres 2 and 3 about a line of rotation 6 via kinematic mounting of the spheres to a machine's table. This line 6 passes through the positions 9 and 10 of the spheres 2 and 3 respectively. Sphere 1 thus moves from position 5 to position 7. Positions 5 and 7 establish a reference line 11 at a right angle with respect to the line of rotation 6. In three dimensions, sphere 1 rotates in a arcuate motion within a plane having line 6 as a normal (perpendicular to the plane). Although, after repositioning sphere 1, reference line 11 may not actually intersect rotation line 6, it lies in a plane that is perpendicular to rotation line 6. By mounting the triple sphere gage on the table of a machine and subsequently measuring the initial positions of spheres 1-3 and rotated position of sphere 1 with sensors (not shown) attached to the tool/probe location of a ram, spindle etc. of a machine, the determination of a machine's ability to place its' tool or probe in an orthogonal manner will be determined. The sensors may be capacitance, linear variable differential transducer, acoustic, eddy current, laser, touch trigger based or any other position or displacement detecting type. A consistent squareness error for machines in general can be determined from the positions provided a consistent framework for defining errors is provided.

By mounting spheres 2-3 utilizing kinematic constraints, they may be rotated around the line through their position centers with an uncertainty on the order of the sphericity of the artifacts. Either spherical artifact 2 or 3 may be mounted on top of three balls with the other on top of two cylinders, a v-surface, or other two-dimensionally constraining mount. These mounts may be magnetically attached to the workpiece mounting surface (e.g. table). Flats can be provided for artifact 1 to rest upon while in position 5 and 7. By placing the kinematic mounts along the nominal center of the laterally moving (shown here left to right) carriage at appropriate locations and the flats along the perpendicular carriage's centerline, we can make a measure of the squareness across the center of the table.

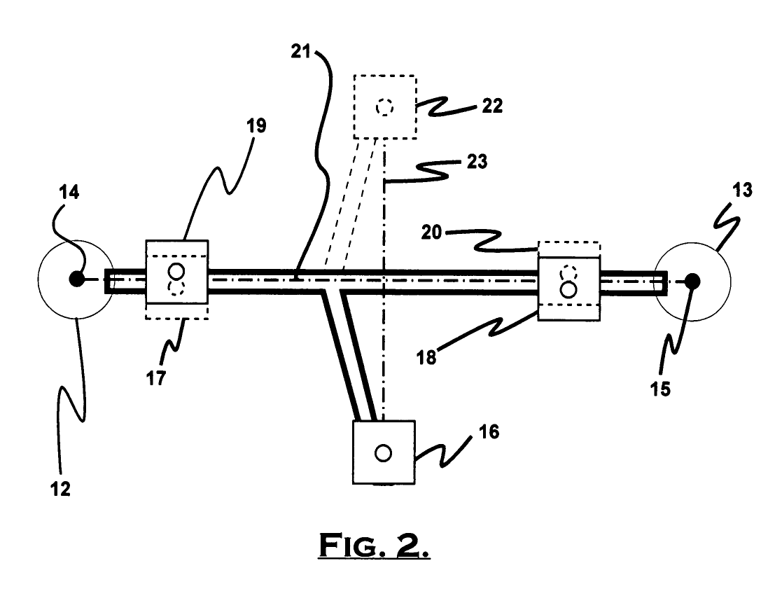

FIG. 2 shows the planar view of a kite square embodiment which has 2 precision spheres 12 and 13 which allow rotation about a predetermined line. Line 21 lies between the centers of spheres 12 and 13. Artifacts in initial positions 16, 17 and 18, rigidly attached to the spheres 2 and 3 as shown, can also provide datums for determining squareness. After a rotation, these artifacts are in positions 22, 17 and 18, respectively. The positions of these artifacts before and after rotation provide orthogonal reference lines 21 and 23 for measuring the out-of-squareness of a machine. If the rotation is a 180 degree flip. The average of positions 17 and 19 lie along line 21 as does the average of positions 18 and 20. Spheres, holes, diaphragms, wires, or other such measurable objects are useful artifacts.

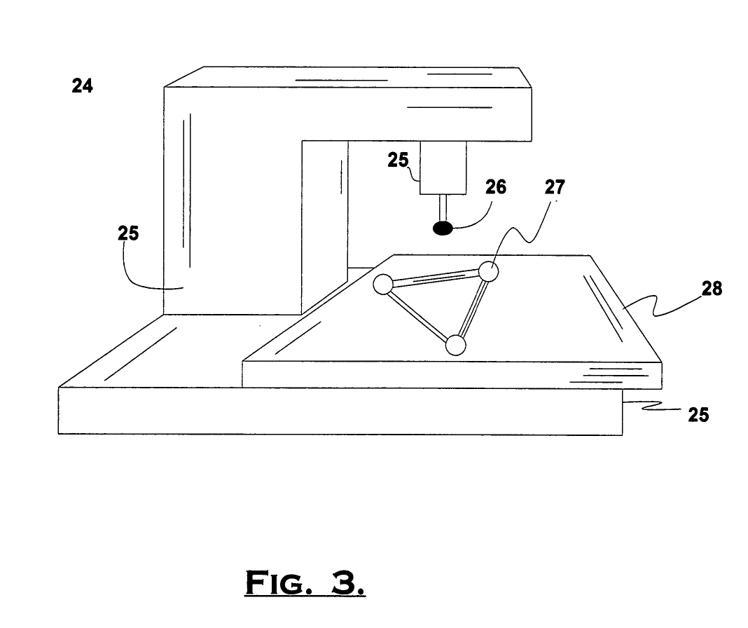

FIG. 3 shows a triangular embodiment of the gage mounted in a first orientation as it would be measured within the working volume of a machine 24 incorporating carriages 25, a probe 26, and table 28.

What is claimed is:

1. A method for determining the out-of-squareness of a machine having a plurality of carriages comprising:
providing a gage having precision spheres and a plurality of non-linearly arranged artifacts, at least one of which substantially non-linear,
attaching the gage in one orientation to the table of a machine via kinematic constraints,
measuring the positions of the artifacts using a probe attached to the machine under evaluation,
rotating the gage about the center of the precision spheres,
remeasuring the gage artifacts in the new position,
calculating the line of rotation and the line from two positions of at least one substantially non-linear artifact,
mathematically determining the out-of-squareness of the two lines as the out-of squareness of the machines carriages.

2. A gage for measuring the squareness error of a machines orthogonal axes comprising a plurality of artifacts for use as datums, one of which is substantially non-linear with respect to the other artifacts and two precision spheres, all connected through a rigid support structure with said spheres kinematically mountable to a machine in a manner providing one degree of rotational freedom about a line through the center of those spheres.

3. The gage of claim 2 which uses holes as artifacts.

4. The gage of claim 2 which uses diaphragms as artifacts.

5. The gage of claim 2 which uses precision spheres as artifacts.

6. The gage of claim 2 which the artifacts and spheres are attached using a triangular shaped rigid support structure.

7. The gage of claim 2 which uses carbon fiber composites for a rigid support frame.

8. The gage of claim 2 which has a rigid support structure composed of multiple parts which can be assembled.

9. The gage of claim 2 which has a rigid support structure composed of multiple parts which can be assembled in a plurality of configurations including major gage size alterations.
